(19) United States
(12) Patent Application Publication
(10) Pub. No.: US 2009/0050582 A1
(43) Pub. Date: Feb. 26, 2009

(54) Self-Cleaning System For Filter

(76) Inventor: Shmuel GIL, Kiryat-Arie (IL)

Correspondence Address: RECHES PATENTS, 211 NORTH UNION STREET, SUITE 100, ALEXANDRIA, VA, 22314, US

(21) Appl. No.: 11/843,710

(22) Filed: Aug. 23, 2007

(51) Int. Cl. B01D 29/62; B01D 35/22

(52) U.S. Cl. 210/798; 210/411; 210/413

(57) ABSTRACT

A self-cleaning system for use with a filter having a fluid inlet station, including (a) a manifold mountable at least for reciprocation along an axis with respect to said filter and comprising at least one suction opening adapted to be in proximity to said station and connectable to a suitable suction source for enabling foreign material to be removed from said filter when said system is installed and in operation with respect to said filter; (b) fluid powered motive means for propelling said manifold along said axis; and (c) a reciprocating mechanism for alternately changing the direction of motion of said manifold along said axis.

### FIELD OF THE INVENTION

This invention relates to continuous flow filter devices, specially such devices that incorporate automatic self-cleaning systems. The invention is particularly concerned with filter self-cleaning systems that are powered by a fluid, and more particularly by the operating fluid that is being filtered.

### BACKGROUND OF THE INVENTION

Filtering systems are widely used for removing particles from liquids. Some such system have a pre-filtering unit equipped with a coarse filter for removing rough particles from the liquid, and a fine filtering unit with a multi-layer sintered filtering element for removing particles, which according to the specific filtering application, may be of a size ranging between 2 and 500 microns, for example.

A problem encountered with such systems is the accumulation of particles and sediments on the filtering element during filtration, which block the filtering apertures or pores of the element. While in some cases, the filtering efficiency is initially increased, such sedimentation leads to a lowering of the flow throughput of the system, and, if untreated, to a full blockage thereof. Such filtration systems thus need to be serviced from time to time, in order to clean or replace the at least partially blocked filter element. In some systems, this would require temporary system shutdown, to enable this work to be carried out.

Self-cleaning filter systems have been developed to enable the filter element to be cleaned in situ without the need for dismantling the system, which is otherwise required for accessing the filter element. In U.S. Pat. No. 6,267,879, an improved continuous filtering apparatus is disclosed, having a preliminary filtering chamber having a liquid inlet and a coarse filtering screen, and a final filtering chamber having a cylindrical multi-layer sintered filtering element in liquid communication with the preliminary filtering chamber across the coarse filtering screen. A filtered liquid chamber is in liquid communication with the final filtering chamber across the sintered filtering element, and has a liquid outlet. An electromechanical cleaning system is provided, adapted to remove sediments from the sintered filtering element, and controlling means enable activation of the cleaning system during the filtration process, for limited periods or continuously, according to the operational mode. The self-cleaning system is based on a back and forth helical motion of a dirt collector having dirt suction members equipped with spraying nozzles. The spraying nozzles use the filtered liquid after being pressurized by a booster pump for vibrating and rinsing the sediments accumulated on the sintered filtering element. The pressure-difference between the liquid within the apparatus and the atmosphere outside of the apparatus is utilized to provide a suction force for the operation of the dirt suction members. The electrical motor is geared to the collector unit through a worm gear for obtaining the helical movement of the collector.

In U.S. Pat. No. 5,228,993, a filter system uses a self-cleaning system comprising a plurality of nozzles that direct a plurality of nozzles sprays onto the clogged filter discs, following a helical path. Both linear and rotational motion to the nozzles may be provided by a single apparatus, which may be powered by hand or by an electric motor, or by separate independent apparatus, such as for example a hand operated or fluid operated piston for the linear motion, and a water powered rotating nozzle for the rotation.

Of general background interest, in U.S. Pat. No. 4,157,251, a spraying system attached to a reciprocating traveler is used for cleaning banks of filters.

### SUMMARY OF THE INVENTION

The present invention relates to, but is limited to, filtration of liquids, irrigation water, recycling of sewage and industrial waste water, recycling of cooling towers water, filtration and purification of drinking water etc.

The present invention provides a high efficiency continuous liquid filtering apparatus having self-cleaning mechanism allowing the continuous filtering operation, i.e. without interrupting the supply of filtered liquid.

In the context of the present invention the term “multi-layer sintered filtering element” relates to any type of metallic body constructed from a plurality of metal screens of different densities or patterns, or of a plurality of metal wires, sintered together for being one integral metallic body useful for the filtration of particles from a substance flowing across its multi layers.

The term “foreign material” refers to any material that is filtered out by the filter and which it is desired to remove therefrom by the self-cleaning action according to the invention.

The present invention relates to a self-cleaning system for use with a filter having a fluid inlet station, comprising:—

a manifold mountable at least for reciprocation along an axis with respect to said filter and comprising at least one suction opening adapted to be in proximity to said station and connectable to a suitable suction source for enabling foreign material to be removed from said filter when said system is installed and in operation with respect to said filter;

fluid powered motive means for propelling said manifold along said axis;

a reciprocating mechanism for alternately changing the direction of motion of said manifold along said axis.

In particular embodiments, the manifold is also adapted for rotation about said axis, and said motive means comprises a rotational motor coupled to said reciprocating mechanism such as to provide a helical motion to said at least one suction opening. The rotational motor comprises at least one arm radiating from said manifold and having a nozzle outlet in communication with said at least one suction opening, said nozzle outlet being tangentially disposed with a direction of rotation of said motor. The rotational motor is coupled to said reciprocating mechanism to provide an endless helical motion to said at least one suction opening. The system may comprise a sliding bearing arrangement for mounting the system with respect to a housing comprising a said filter.

In one embodiment, the rotational motor and said reciprocating mechanism comprise a follower coupled to a cylindrical cam arrangement, and wherein said cam comprises an endless track adapted for enabling the follower to reciprocate along said axis in response to a relative rotation between said cam and said follower about said axis. The endless track typically comprises twin parallel helical tracks wound in opposite directions one with respect to another, and joined together at longitudinal ends via corner portions. The cylindrical cam may be fixedly mountable to a housing comprising said filter and said follower is mounted to said manifold for rotation therewith, when the system is installed with respect to said filter. Alternatively, the follower is fixedly mountable to a housing comprising said filter and said cylindrical cam is mounted to said manifold for rotation therewith, when the system is installed with respect to said filter.

In another embodiment, the rotational motor and said reciprocating mechanism comprise a follower coupled to an end cam arrangement, and wherein said end cam comprises an endless track adapted for enabling the follower to reciprocate along said axis in response to a relative rotation between said cam and said follower about said axis. The endless track typically comprises an endless undulating contour comprising a plurality of peaks smoothly joined with a number of intercalated troughs, arranged in an annular manner. The peaks and troughs may merge into one another in a substantially sinusoidal manner in a circumferential direction. The follower may be mounted to a gear arrangement coupled to said rotational motor. The gear arrangement typically comprises a planetary gear arrangement, wherein said rotational motor is mounted for rotation with a sun gear and said follower is mounted for rotation with an orbital gear of said planetary gear arrangement. The end cam may be fixedly mountable to a housing comprising said filter and said follower is mounted to said manifold for rotation therewith, when the system is installed with respect to said filter. Alternatively, the follower is fixedly mountable to a housing comprising said filter and said end cam is mounted to said manifold for rotation therewith, when the system is installed with respect to said filter.

In another embodiment, the rotational motor and said reciprocating mechanism comprise a shuttle arrangement mounted on an axial rail support for axial translation with respect thereto, said rail being fixedly mountable to a housing comprising said filter when the system is installed with respect to said filter, said shuttle being coupled to said rotational motor such that a rotation of said motor about said axis provides a translation of said shuttle along said rail. The shuttle may comprise:
a frame axially displaceable with respect to said rail and comprising a pivoting plate having two end pivot positions, said plate comprising a first gear means mounted for rotation at the pivot thereof and coupled to said rotational motor, said pivoting plate further comprising second and third gear means in mesh engagement with the other, wherein said second gear means is in mesh engagement with said first gear means via a fourth gear means carried on said pivoting plate;
first moving means coupled to a fifth gear means and second moving means coupled to a sixth gear means, each one of said second and third gear means being in alternate mesh engagement with one or the other of said fifth gear means and said sixth gear means in respective said end pivot positions of said plate;
toggle means for pivoting said plate at each said end pivot position for reversing a direction of motion of said shuttle along said rail.

The second and third gear means typically comprise substantially the same pitch diameter. The toggle means typically comprises an arm joined to said plate and extending radially from said plate, and adapted for interacting with one or another of fixed stops for pivoting said plate at each said end pivot position. This embodiment typically further comprises a pin joined to said frame and extending through a slot in the plate. The slot defines the end pivot positions of said plate. The first gear may be coupled to said rotational motor via a worm gear arrangement.

In another embodiment, the motive means comprises a fluid powered linear motor coupled to said reciprocating mechanism such as to provide at least axial reciprocating motion to said at least one suction opening. The linear motor may comprise at least one nozzle arrangement having a nozzle head comprising first and second fluid passages alternately in communication with a fluid source, said first and second fluid passages comprising fluid outlets at angles A and B, respectively to a tangential direction, said tangential direction being substantially parallel to said station when said system is installed and in operation with respect to said filter. The nozzle head may be slidingly mounted with respect to an arm between two end positions, said arm in communication with said fluid source, and comprising toggle means for sliding said nozzle head at each said end position for reversing a direction of motion of said at least one suction opening along said axis. These toggle means may comprise a tab joined to said nozzle head and extending away from a direction of said arm, and adapted for interacting with one or another of fixed stops for pivoting said plate at each said end pivot position. Angle A may be about +90° and angle B may be about −90°. The manifold is typically also adapted for rotation about said axis, and the motive means further comprises a rotational motor coupled to said reciprocating mechanism such as to provide a helical motion to said at least one suction opening. The system comprises a sliding bearing arrangement for mounting the system with respect to a housing comprising a said filter. The manifold is also adapted for rotation about said axis, and wherein said motive means further rotational motion to said manifold, such as to provide a net helical motion to said at least one suction opening. In this embodiment, angle A may be set at +α and angle B at −α, wherein the magnitude of α is substantially greater than 0° and less than about 90°. For example, the magnitude of α is about 45°. The system comprises a sliding bearing arrangement for mounting the system with respect to a housing comprising a said filter.

Optionally, and for all embodiments, the manifold may comprise a plurality of arms radiating from a conduit coaxial with said axis, and comprising a said suction outlet at the extremity of each said arm. The arms may be located singly or in groups at axial locations uniformly distributed at a pitch P. Preferably, the axial travel of said system in one or another direction along said axis is correlated to said pitch P. Typically, the number of revolutions of said manifold about said axis, the number of arms at each axial location, and the axial width of said suction openings are correlated to said pitch P. Preferably, the system further comprises a spray nozzle at each said arm adapted for spraying a fluid towards said station when the system is installed in a housing comprising said filter.

The present invention also relates to a self-cleaning filter assembly adapted for connection to a fluid source, comprising:

a housing comprising a filter accommodated therein, said filter having a fluid inlet station, said housing having at least one fluid inlet in communication with fluid inlet station, and at least one fluid outlet in communication with a fluid outlet station of said filter;

the self-cleaning system of the invention.

The filter is typically substantially tubular and said filter fluid inlet station is substantially cylindrical. The manifold typically comprises an outlet providing fluid communication between said at least one suction opening and a drain chamber. The drain chamber typically comprises at least one valve open to the atmosphere during operation of said self-cleaning system. The filter typically comprises a sintered filtering element. The assembly may further comprise a preliminary coarse filtering element upstream of said sintered filtering element. The assembly may further comprise at least one differential pressure detector coupled to said system and adapted for activating said system when the differential pressure detected between said filter inlet and said filter outlet is lower than a predetermined threshold. The assembly may further comprise at least one timer coupled to said system and adapted for activating said system at predetermined times. The assembly may further comprise a by-pass switch coupled to said system and adapted for selectively activating said system on user demand.

The motive means are typically powered by the operating fluid that it is desired to be filtered by said filter, the operating fluid typically being water.

The present invention is also directed to a method for cleaning a filter having a fluid inlet station, comprising:—

reciprocating a manifold along an axis with respect to said filter, said manifold comprising at least one suction opening adapted to be in proximity to said station and connectable to a suitable suction source for enabling foreign material to be removed from said filter when said system is installed and in operation with respect to said filter, wherein a fluid powered motive means propels said manifold along said axis, and a reciprocating mechanism for alternately changing the direction of motion of said manifold along said axis.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 illustrates in longitudinal cross-sectional view a filter apparatus which incorporates a self-cleaning system according to the present invention;

FIG. 2 illustrates, in fragmented longitudinal cross-sectional view, a first embodiment of a reciprocating mechanism used in the self-cleaning system of the invention;

FIGS. 3a to 3e illustrates in greater detail the cylindrical cam used in the embodiment of FIG. 2: FIG. 3a—the cam in plan view; FIG. 3b—the cam in side view; FIG. 3d—the follower engaged in a groove in one direction; FIG. 3e—the follower engaged in a groove in an opposed direction to that of FIG. 3d; FIG. 3e—the follower changing direction with respect to the cam;

FIG. 4 illustrates, in fragmented longitudinal cross-sectional view, a second embodiment of a reciprocating mechanism used in the self-cleaning system of the invention;

FIG. 5 illustrates, in fragmented longitudinal cross-sectional view, a third embodiment of a reciprocating mechanism used in the self-cleaning system of the invention;

FIG. 6 illustrates in isometric view the edge cam used in the embodiment of FIG. 5;

FIG. 7 illustrates, in fragmented longitudinal cross-sectional view, a fourth embodiment of a reciprocating mechanism used in the self-cleaning system of the invention;

FIG. 8 illustrates, in fragmented longitudinal cross-sectional view, a fifth embodiment of a reciprocating mechanism used in the self-cleaning system of the invention, wherein the mechanism is translating in one axial direction;

FIG. 9 illustrates, in fragmented longitudinal cross-sectional view, the embodiment of FIG. 8, wherein the mechanism is translating in an axial direction opposed to that of FIG. 8;

FIG. 10 illustrates, in a view taken along the longitudinal axis, the embodiment of FIGS. 8 and 9;

FIG. 11 illustrates, in fragmented longitudinal cross-sectional view, a sixth embodiment of a reciprocating mechanism used in the self-cleaning system of the invention, wherein the mechanism is translating in one axial direction;

FIG. 12 illustrates, in fragmented longitudinal cross-sectional view, the embodiment of FIG. 11, wherein the mechanism is translating in an axial direction opposed to that of FIG. 11;

FIG. 13 illustrates, in fragmented longitudinal cross-sectional view, the nozzle mechanism of the embodiment of FIGS. 11 and 12;

FIG. 14 illustrates, in cross-sectional view, the embodiment of FIG. 13 taken along A-A;

FIG. 15 illustrates, in fragmented longitudinal cross-sectional view, a nozzle mechanism of a seventh embodiment of a reciprocating mechanism used in the self-cleaning system of the invention; and

FIG. 16 illustrates, in cross-sectional view, the embodiment of FIG. 15 taken along B-B.

### DETAILED DESCRIPTION OF THE INVENTION

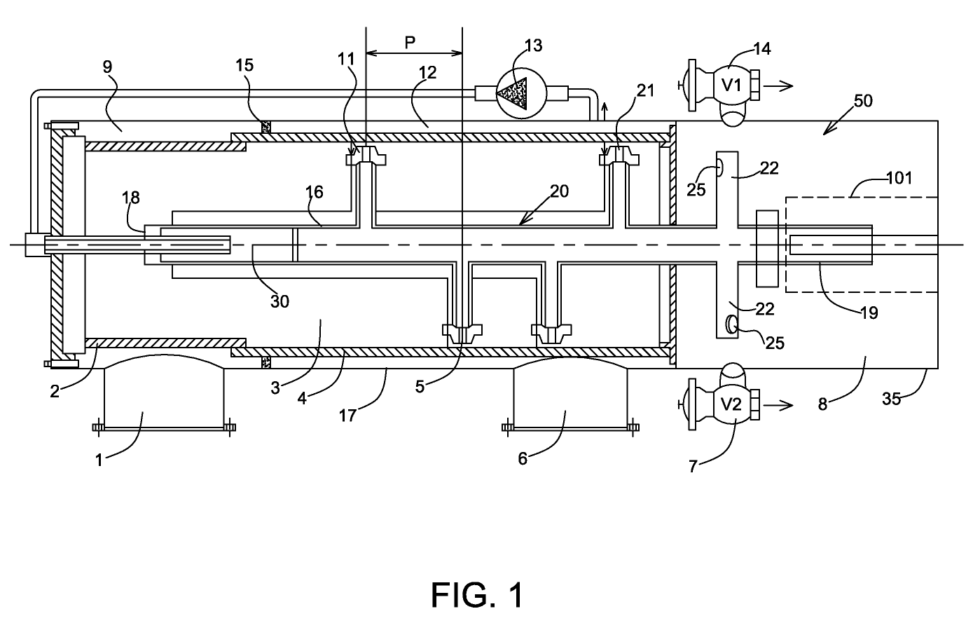

FIG. 1 illustrates a typical continuous filter apparatus which may incorporate a self-cleaning system according to the present invention. Such an apparatus may be similar to that described in U.S. Pat. No. 6,267,879, the contents of which are incorporated herein in their entirety. Of course, the self cleaning system of the present invention may be incorporated in any suitable filtering apparatus or system, in a similar way to that described herein, mut ats mutandis.

The continuous filter apparatus, generally designated with the numeral 10, comprises an elongated tubular casing 17 having liquid inlet 1 for a connection with a liquid source that provides liquid to be filtered during filtering operation of the apparatus 10. The liquid inlet 1 feeds liquid from the liquid source to an annular first filtering chamber 9 that is in fluid communication with a second filtering chamber 3 via a cylindrical coarse screen 2, which is adapted for removing rough particles from the liquid. Pre-filtered liquid obtained downstream of the coarse screen 2 flows through a cylindrical sintered filtering element 4 to the filtered liquid chamber 12, and from there to the liquid outlet 6, which is adapted for a connection to a filtered liquid duct or reservoir (not illustrated). Advantageously, the first filtering chamber 9 and the filtered liquid chamber 12 are formed as two co-axial annular compartments within a single tubular envelope, separated one from the other by an annular bulkhead 15, which is located between the sintered filtering element 4 and the inner cylindrical surface of the tubular body 17.

A collector manifold assembly 20 comprises an elongated collection tubing 16 substantially co-axial with the sintered filtering element 4, and further comprises a plurality of suction arms 5 radiating from tubing 16. Typically, four to six arms may be provided, though less than four or more than six arms may also be provided. The arms 5 are located at stations on the tubing 16 that are axially spaced with respect to axis 30 in a typically uniform manner, at a pitch P. At each station, one or more arms 5 may be provided, and in any case, care is taken to distribute the arms 5 circumferentially about axis 30, and axially on axis 30, to provide static as well as dynamic balance with respect to axis 30.

Each suction arm 5 comprises a suction aperture 21 that faces and is in close proximity to the inner cylindrical surface of the filter 4, which can become clogged with filtered-out particles, and further comprises an adjacent spray nozzle 11 attached to the arm 5. The suction apertures are in fluid communication with a suction source, via the hollow arms 5 and hollow tubing 16, as will be further described herein. The manifold 20 is mounted for axial and rotational motion within the filter body 17 by means of suitable sliding bearing arrangements 18, 19, provided at the axial ends of the manifold 20.

As will be described in greater detail hereinbelow, when the self-cleaning system is in operation, the manifold 20 is rotated and simultaneously reciprocated with respect to the axis 30. In so doing, each of the suction apertures 21, and their corresponding spray nozzles 11, travel along a predetermined helical path in one axial direction and then along a reversed helical path back again to their original axial position with respect to the axis 30. The total axial displacement of the manifold 20 in any direction along axis 30 is typically similar to or greater than the pitch P, and the axial displacement for every full revolution of the manifold 20 is related to the number of arms 5 at each station, and the effective width of the suction nozzles 21.

The axial sliding movement in one direction is thus restricted between a minimum point at which the right-most pair of the suction apertures 21 and spraying nozzles 11 (FIG. 1) is brought to the right end of the sintered filter 4, and a maximum point at which the left-most pair of the suction members and spraying nozzles is brought to the left end of the sintered filter 4.

In this manner, during operation of the self-cleaning system, as the manifold 20 is rotated and displaced along axis 30 in one direction, the nozzles 21 are brought in close proximity to every part of the inside cylindrical surface of filter element 4, which is thus fully scanned, and a second time again as the manifold is returned in the opposite direction to its original axial position. Thus, the arrangement enables each part of the filter element 4 to be cleaned of sediment in one to and fro scan of the cleaning system.

Simultaneously with the helical movement of the suction manifold 20, a booster-pump 13, fed with liquid taken from the filtered liquid chamber 12, is adapted for generating a relatively high liquid pressure at the spraying nozzles 11 during operation of the cleaning system. Thus, a liquid stream is sprayed from each of the nozzles 11 toward the inner surface of the sintered filter 4, vibrating the dirt sediment and particles that may be trapped within the porous filter 4. At the same time, liquid is sucked into the suction apertures 21 of the manifold 20, back-washing and sweeping away the dirt from the filter 4. Material sucked from the chamber 3 into the apertures 21 flow under pressure to a collection chamber 8 via drain apertures 25 that are provided at one end of the tubing 16. The suction operation is generated automatically by the pressure difference that exists between the relatively high pressure liquid upstream of the filter 4, i.e., in the second filtering chamber 3, and free atmospheric pressure, via openings 25 the draining valves 7, 14, which are in open position to the atmosphere during the cleaning operation.

A cleaning operation for the cleaning system may be activated by means of a differential pressure sensor or gauge (not illustrated) adapted for identifying a predetermined differential pressure between the final filtering chamber 3 and the filtered liquid chamber 12, indicating that a certain amount of sediments blocks the sintered filter, thus a cleaning operation is required. A programmable logic controller (not illustrated) may be utilized for controlling the operation of the cleaning system for limited periods and/or according to a timer. The timer (not illustrated) may be adapted for activating the cleaning system periodically for preventing sedimentation in case of the filtration of a relatively clean liquid which enables the differential pressure sensor to activate the cleaning system only infrequently. Both, the differential pressure sensor operating mode and the timer operating mode, may be by-passed by a continuous-operation-switch (not illustrated) which enables a user to selectively activate the cleaning system whenever desired, independently of the actual conditions of the filter, or the time elapsed from the previous cleaning cycle.

The drain apertures 25 are configured as reaction nozzles provided at the radial end of an additional pair of arms 22 that are diametrically joined to an axial portion of the tubing 16 that is within the draining chamber 8. The apertures 25 are arranged in the same angular direction with respect to axis 30. Thus, during operation of the cleaning system, dirt and liquid are sucked through the apertures 21 and are ejected out of the drain nozzles 25, which provide a reaction couple causing rotation of the manifold 20 about the axis 30. Thus, the arrangement of drain nozzles 25 and arms 22 comprises a hydraulic motor, herein designated with the numeral 50.

Suitable liquid-driven axial reciprocation motive means according to the present invention, schematically illustrated in FIG. 1 by a dotted box 101, provide reciprocating axial motion to the manifold 20, typically during rotation of thereof.

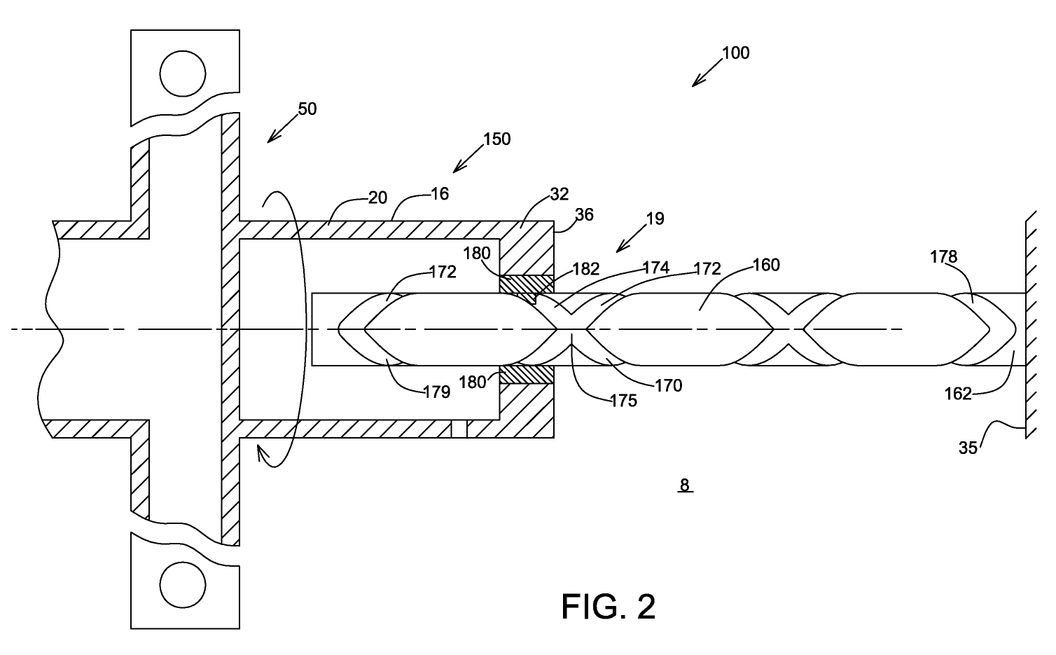

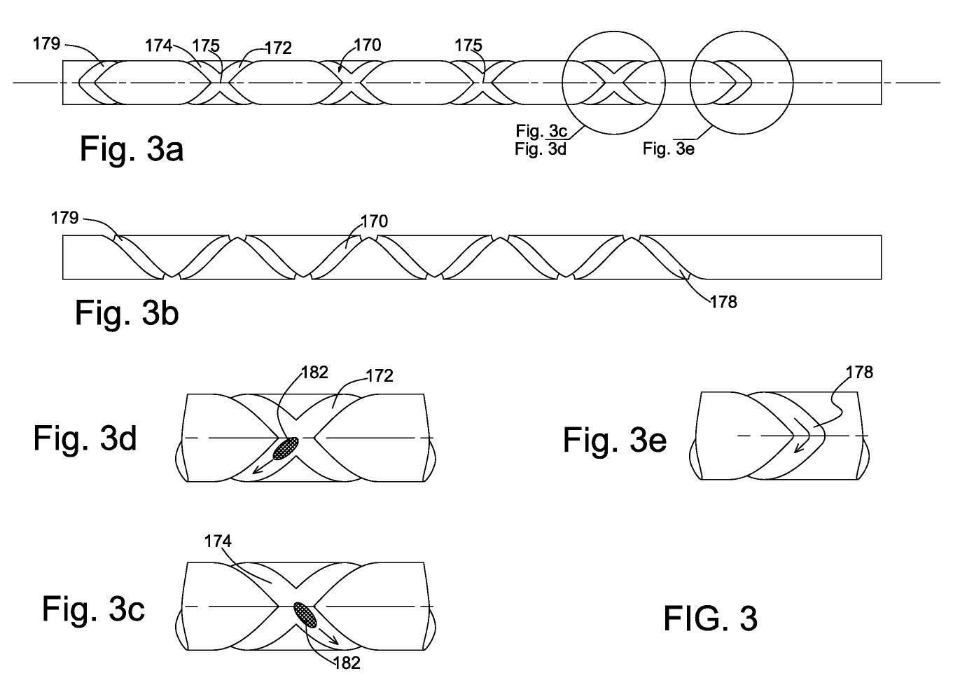

Referring to FIGS. 2 and 3a to 3e, a first embodiment of the cleaning system of the present invention, generally designated with the numeral 100, comprises a manifold 20 including hydraulic motor 50 as described above, and a reciprocating mechanism 150. The reciprocating mechanism is coupled to the motor 50 and adapted for converting rotational motion provided by the motor 50 into reciprocating linear motion along axis 30. Thus, the helical motion that may be provided to the suction apertures 21 and spray nozzles 11 are powered by the hydraulic motor 50.

The reciprocating mechanism 150 comprises a cylindrical cam 160 axially and rigidly cantilevered at one end 162 thereof to the longitudinal end plate 35 of the drain chamber 8. Referring in particular to FIGS. 3a and 3b, the cylindrical cam 160 comprises a single, endless groove 170 that comprises a clockwise helical section 172, and a parallel but anticlockwise helical section 174, which cross at periodic intersections 175, and joined at their axial ends thereof by respective connecting corner intersections 178, 179.

The end 32 of the conduit 16 of manifold 20 comprising the motor 50 further comprises an axial opening 36 adapted for reciprocably and rotatingly receiving the free end 164 of the cylindrical cam 160 by means of said sliding bearing arrangement 19. The sliding bearing arrangement 19 comprises a suitable collar 180 mounted to said axial opening 36. The inner cylindrical surface of the collar is adapted for rotation over the roller cam 160, and further comprises a follower 182 radially projecting towards said axis 30 and engaged with respect to said grove 170.

As the manifold 20 is rotated about axis 30 under the action of the liquid motor 50, the end 32 rotates about the static cylindrical cam 160, and the follower 182, together with the manifold 20, is constrained to follow a path defined by the endless groove 170, as follows. Starting at free end 164, the follower 182 translates along groove 174 in an axial direction towards end 162, as the follower 182 also revolves around the cam 160, as illustrated in FIG. 3c. At end 178, the follower 182 changes axial direction (FIG. 3e) and enters groove 172, translating the follower 182 towards free end 164, as illustrated in FIG. 3d, where at the end 179, the follower 182 again changes axial direction as it enters groove 172 once again. The number of revolutions required for the follower 182 to travel from end 179 to end 178 is related to the relative width of the suction apertures 21 with respect to the pitch P.

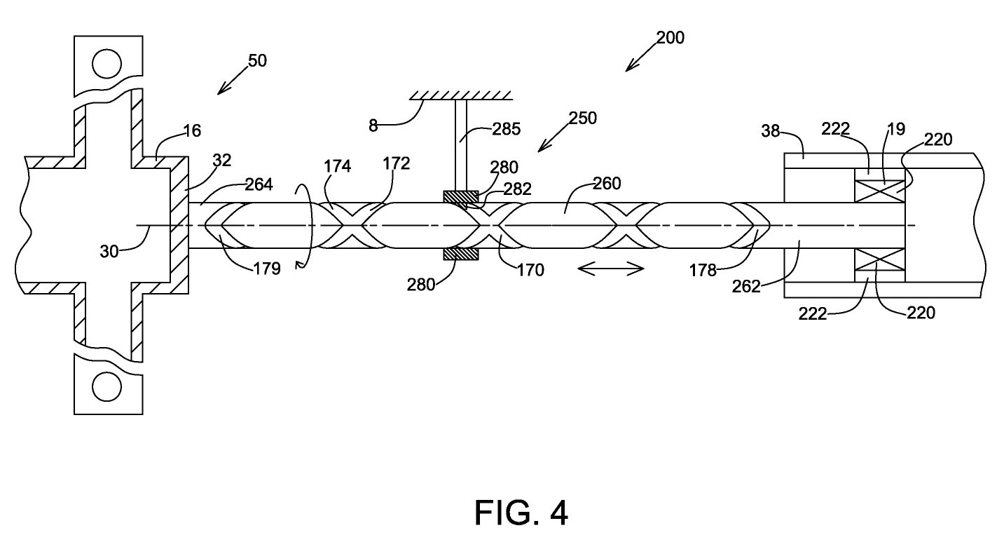

Referring to FIG. 4, a second embodiment of the cleaning system of the present invention, generally designated with the numeral 200, is similar to the arrangement described above for the first embodiment, mutatis mutandis, with the main difference that in the second embodiment the cylindrical cam, herein designated with the numeral 260, oscillates with the manifold 20, and the follower 282 is statically mounted to the chamber 8. Thus, the cleaning system 200 comprises a manifold 20 a reciprocating mechanism 250 that is coupled to the motor 50 and adapted for converting rotational motion provided thereby into reciprocating linear motion along axis 30.

The reciprocating mechanism 250 comprises said cylindrical cam 260, axially and rigidly cantilevered at one end 264 thereof to end 32 of the conduit 16 of manifold 20 comprising the motor 50, the cam 260 comprising an endless groove 170, as described for the first embodiment, mutatis mutandis.

The end 35 of the chamber 8 further comprises a tubular sleeve 38 adapted for reciprocably and rotatingly receiving the free end 262 of the cylindrical cam 260 by means of said sliding bearing arrangement 19. The sliding bearing arrangement 19 in this embodiment comprises a bearing 220, the inner rotating shell of which is mounted at the end 262, and the outer static shell being statically mounted to a sliding ring 222, which is adapted for sliding within said sleeve 38.

The draining chamber 8 further comprises a suitable collar 280 statically mounted to the chamber via strut 285. The inner cylindrical surface of the collar is adapted for rotation over the roller cam 260, and further comprises a follower 282 radially projecting towards said axis 30 and engaged with respect to said grove 170. Alternatively, the collar 280 may be mounted in the sleeve 38. Alternatively, the collar 280 may be incorporated in the bearing arrangement 19, similar to that described for the first embodiment, mutatis mutandis.

Thus, as the manifold 20 is rotated about axis 30 under the action of the liquid motor 50, the end 32 rotates together with cylindrical cam 260, and the follower 282 causes the cam 260, together with the manifold 20, to follow a path defined by the endless groove 170, as follows. Thus, while rotating about axis 30, the cam 260 translates along groove 174 in an axial direction towards end 178 with respect to follower 282, and changes direction thereat to present groove 172 to the follower 282, translating the cam 260 back so that free end 164 approaches follower 220, in a cyclic manner, to oscillate the cam 260 with respect to the follower 282. In a similar manner to that described for the first embodiment, the number of revolutions required for the cam 260 to travel with respect to the follower 182, from end 179 to end 178, is related to the relative width of the suction apertures 21 with respect to the pitch P.

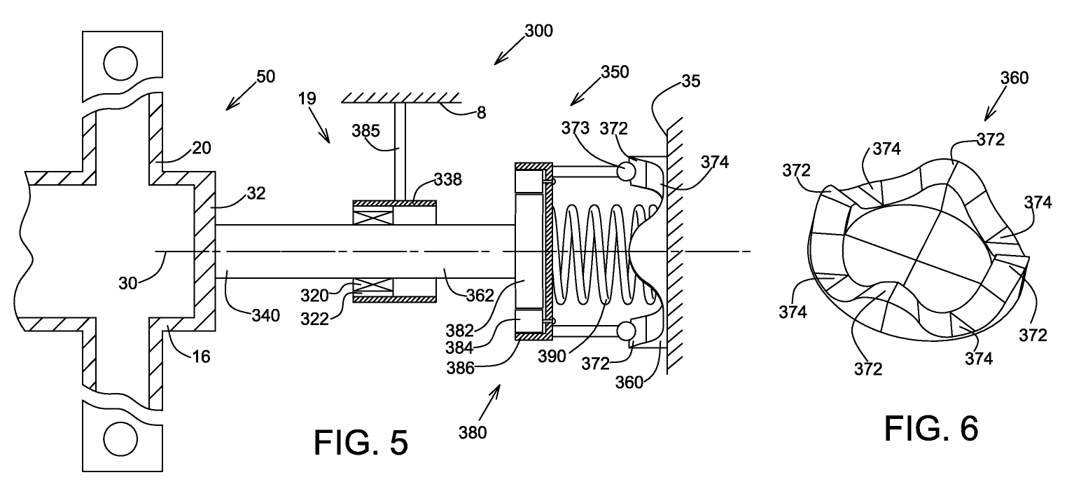

Referring to FIG. 5, a third embodiment of the cleaning system of the present invention, generally designated with the numeral 300, comprises a manifold 20 including hydraulic motor 50 as described above, and a reciprocating mechanism 350. The reciprocating mechanism 350 is coupled to the motor 50 and adapted for converting rotational motion provided by the motor 50 into reciprocating linear motion along axis 30. Thus, the helical motion that may be provided to the suction apertures 21 and spray nozzles 11 are powered by the hydraulic motor 50.

The reciprocating mechanism 350 comprises an end cam 360 axially and rigidly mounted to end plate 35 of the drain chamber 8. Referring in particular to FIG. 6, the end cam 360 comprises a single, endless undulating contour 370 that a number of peaks 372 smoothly joined with a number of intercalated troughs 374, arranged in an annular manner. In the illustrated example of FIGS. 4 and 5, four identical troughs 374 and four identical peaks 372 are provided, and the peaks and troughs merge into one another in a substantially sinusoidal manner in the circumferential direction. The end cam 360 is coaxially aligned with axis 30.

The end 32 of the conduit 16 of manifold 20 comprising the motor 50 further comprises a shaft 340 axially mounted thereto. The draining chamber 8 comprises a tubular sleeve 338 statically mounted to the chamber via strut 385. the sleeve 338 is adapted for reciprocably and rotatingly receiving the shaft 340 by means of said sliding bearing arrangement 19. The sliding bearing arrangement 19 in this embodiment comprises a bearing 320, the inner rotating shell of which is mounted to shaft 340, and the outer static shell being statically mounted to a sliding ring 322, which is adapted for sliding within said sleeve 338.

At the free end 362 of the shaft 340 is mounted a sun gear 382 of a planetary gear arrangement 380, which comprises a number of planetary gears 384 mounted for rotation on planetary carrier 386. The planetary carrier 386 comprises one or a number of followers 373 axially projecting therefrom towards the cam 370. A spring 390, mounted to the center of the cam 360 and to the opposed center of the planetary carrier 386, forces axial contact between the follower 373 and the cam 370. The spring 390 is mounted in such a way, and/or is configured, such as not to become tangled or overwound as the planetary gear 386 revolves with respect to the cam 370. Alternatively, the spring may be replaced by a rail arrangement that constrains the follower 373 to follow the cam 370 as it rotates about the same.

As the manifold 20 is rotated about axis 30 under the action of the liquid motor 50, the end 32 rotates about the static end cam 360, and the follower 373, together with the gear arrangement 380 and manifold 20, is constrained to follow a path defined by the endless contour 370, as follows. Starting at one trough 374, the follower 373 translates in an axial direction away from end 35 as the follower 373 also revolves partially around the cam 360 until it reaches the adjacent peak 372. Then, the follower 373 changes axial direction and towards end 35 as it approaches the next trough 374. The number of revolutions required for the follower 373 to travel between adjacent troughs 374, and the gear ratios of gear arrangement 380, are related to the relative width of the suction apertures 21 with respect to the pitch P.

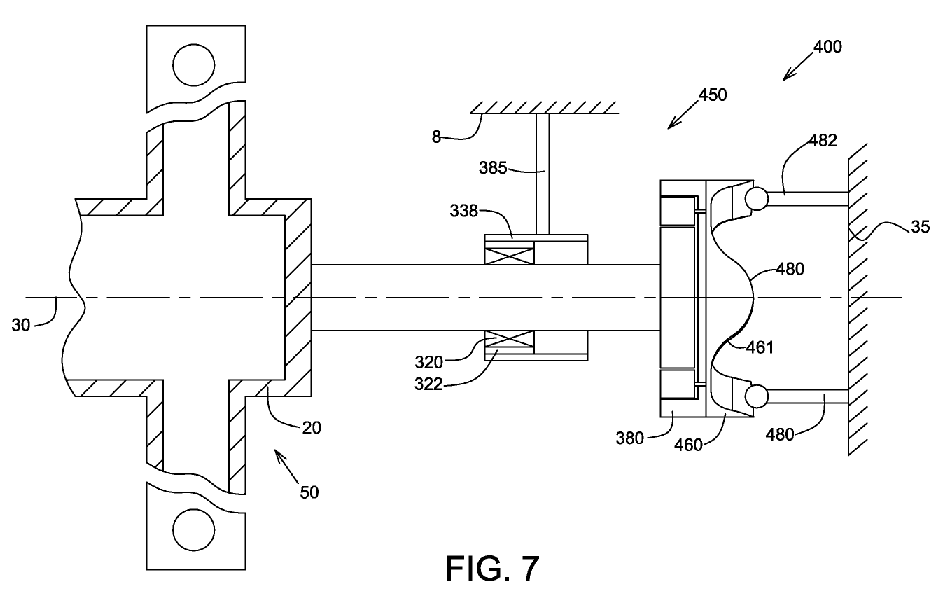

Referring to FIG. 7, a fourth embodiment of the cleaning system of the present invention, generally designated with the numeral 400, is similar to the arrangement described above for the third embodiment, mutatis mutandis, with the main difference that in the fourth embodiment the end cam, herein designated with the numeral 460, oscillates together with the gear arrangement 380, and thus with the manifold 20, and the follower 482 is statically mounted to the end wall 35 of chamber 8. In the illustrated embodiment, the cam 460 comprises a rail arrangement 461 that constrains the follower 482 to follow the contour 480 as it revolves with respect to axis 30. Operation of this embodiment is similar to that of the third embodiment, mutatis mutandis.

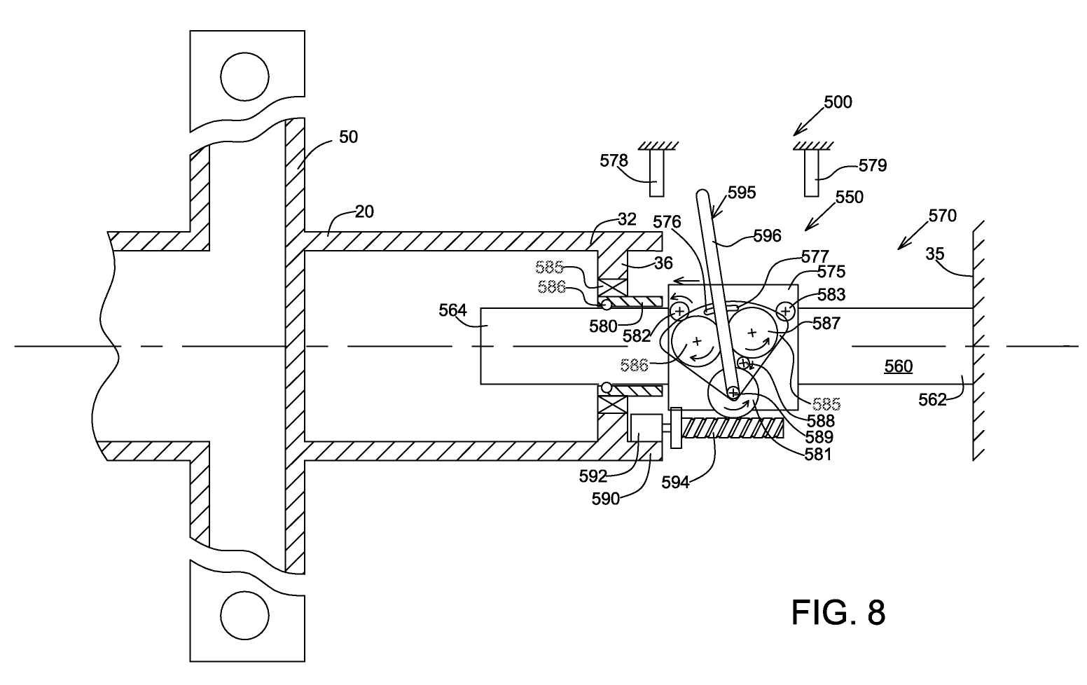

Referring to FIGS. 8 to 10, a fifth embodiment of the cleaning system of the present invention, generally designated with the numeral 500, comprises a manifold 20 including hydraulic motor 50 as described above, and a reciprocating mechanism 550. The reciprocating mechanism is coupled to the motor 50 and adapted for converting rotational motion provided by the motor 50 into reciprocating linear motion along axis 30. Thus, the helical motion that may be provided to the suction apertures 21 and spray nozzles 11 are powered by the hydraulic motor 50.

The reciprocating mechanism comprises a rail 560 of substantially rectangular cross-section axially and rigidly cantilevered at one end 562 thereof to end plate 35 of the drain chamber 8.

The end 32 of the conduit 16 of manifold 20 comprising motor 50 further comprises an axial opening 36 adapted for reciprocably and rotatingly receiving the free end 564 of the rail 560 by means of sliding bearing arrangement 19. In this embodiment, the sliding bearing arrangement comprises a suitable collar 580 mounted to said axial opening via bearing 585. The collar 580 comprises an inner rectangular opening and sliding guides 586 for sliding the collar axially along the said rail 560, and an outer typically cylindrical surface for connection to the inner race of the bearing 585 which remains static when the outer race of the bearing rotates with the manifold 20. Thus the outer race of the bearing 585 is fixed to the axial opening 36.

Referring particularly to FIG. 10, the reciprocating mechanism 550 further comprises a shuttle mechanism 570, in the form of a frame 575 comprising two drive rollers 572, 573 rotatingly mounted thereto, and used alternately for driving the shuttle in one direction or the other along the rail 560. Each of the drive rollers 572, 573 is axially mounted to a gear wheel 582, 583, respectively. The frame 575 is connected to the collar 580.

Alternatively, the upper surface of the rail 560 may comprise a rack, and the drive rollers 572, 573 replaced with drive pinions for better traction of the shuttle 570 with respect to the rail 560.

Alternatively, the rail may be of circular section, for example, and the rollers are appropriately shaped to enable rolling over a convex cylindrical surface.

As illustrated in FIG. 10, the shuttle 570 may further comprise additional loose guide rollers 564 mounted on the frame 575 for free rotation with respect to the lower and vertical surfaces of the rail.

A plate 585 is pivotably mounted to the frame 575 at pivot 589. The plate 585 can pivot about pivot 589 about a pivot arc between two end positions, defined by a stop pin 576 mounted to plate 585 and sliding in an arcuate guide slot 577 in frame 575. A first gear wheel 581 is rotatingly mounted to the plate at pivot 589, and is in mesh with a gear wheel 586 via intermediate gear wheels 587 and 588, all of which are carried by the plate 585. Wheels 586 and 587 are centered on an arch of constant radius about pivot 589, and wheels 581, 588 and 587 have their centers rectilinearly aligned. Wheels 586 and 587 have the same pitch diameter, and the said pivot arc of the plate 585 is such that in either of the end positions, one or the other of wheels 586 and 587 meshes with one or the other of gear wheels 582, 583, respectively.

Alternatively, wheels 581 and 587 could be engaged one with the other by means of a belt, rather than wheel 588, mutatis mutandis.

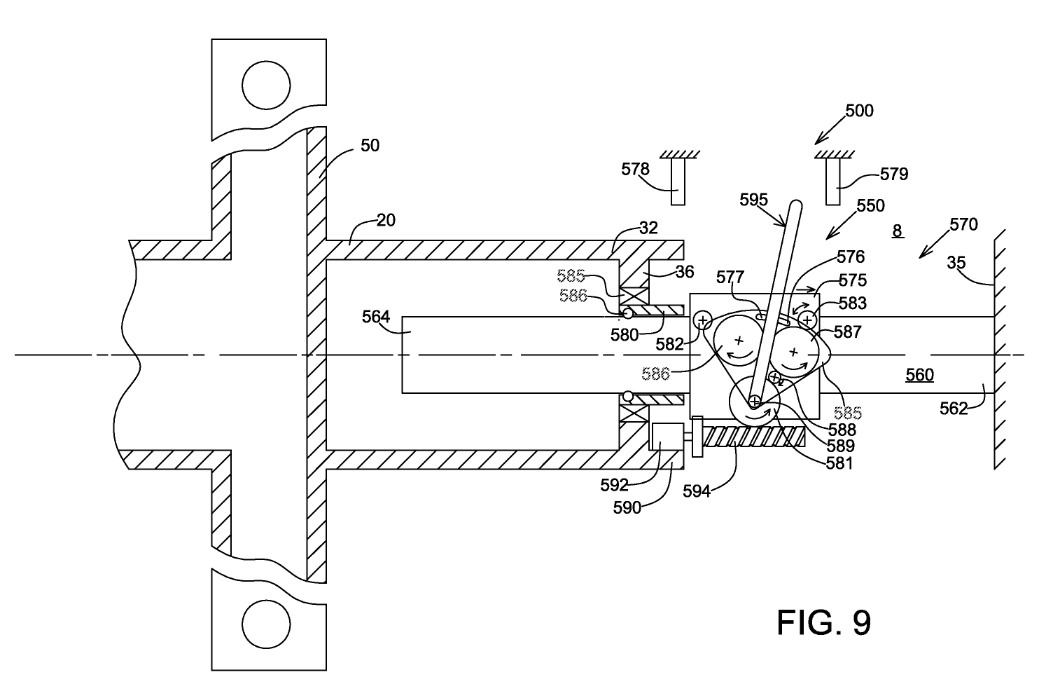

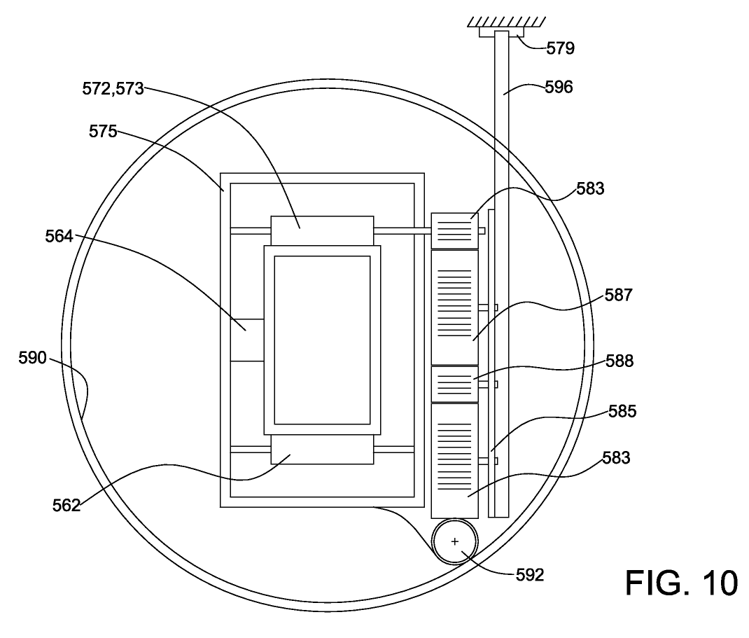

Thus, referring to FIG. 8, when the plate 585 is at the end position such that wheel 586 is engaged with wheel 582, counterclockwise rotation of wheel 581 produces counterclockwise rotation of wheel 582, which causes the shuttle 570 to travel away from end plate 35. Conversely, and referring to FIG. 9, when the plate 585 is at the end position such that wheel 587 is engaged with wheel 583, counterclockwise rotation of wheel 581 produces clockwise rotation of wheel 583, which causes the shuttle 570 to travel towards the end plate 35.

The end 32 further comprises an internal gear 590 which meshes with gear wheel 592 carried on frame 575. A worm gear 594 axially connected to wheel 592 meshes with wheel 581.

The shuttle 570 further comprises a toggle mechanism 595 for changing direction thereof between two axially distanced stops 578, 579 mounted in the drain chamber 8. The toggle mechanism 595 comprises an arm 596 fixed to plate 585 and radially extending from pivot 589 such as to engage with one or another of stops 578, 579 when the shuttle 570 reaches one or another of the axial end positions thereof.

Thus, as the manifold 20 is rotated about axis 30 under the action of the liquid motor 50, the end 32 rotates about the rail 560, and the shuttle 570, together with the collar 580 and manifold 20, is constrained to follow a reciprocating path with respect to the rail 560 as follows. Starting at or near free end 564, the arm 596 is pressed against stop 578 such as to pivot the plate 585 to the position illustrated in FIG. 9, so that wheel 587 is meshed with wheel 583, and wheel 586 is disengaged from wheel 582. The rotation of the manifold 20 causes wheel 581 to turn in a counterclockwise direction by virtue of internal gear 590, wheel 592 and worm gear 594. In turn, wheel 581 turns wheel 583 in a clockwise direction, via wheels 588 and 587, which rotates drive roller 573, translating the shuttle 570 towards the end plate 35. When the shuttle 570 nears the end plate 35, arm 596 presses against the stop 579, and the momentum of the shuttle 570 carries the same a little further such as to pivot the arm 579 to the position illustrated in FIG. 8. Now, wheel 586 is meshed with wheel 582, and wheel 587 is disengaged from wheel 583. Thus, while the manifold 20 continues to rotate in the same direction, counterclockwise rotation of wheel 581 results in counterclockwise rotation of wheel 582, which rotates drive roller 572, translating the shuttle 570 away from the end plate 35. When the shuttle 570 nears the free end 564, arm 596 now presses against the stop 578, and the momentum of the shuttle 570 carries the same a little further such as to pivot the arm 579 back to the position illustrated in FIG. 9. So long as the motor 50 is rotating, the shuttle 570 will be translating the manifold 20 in one or the other axial directions. The full axial travel in either direction for the shuttle 570 is typically correlated to the dimension of pitch P, and in some embodiments may be set at about equal to the dimension of P.

The number of revolutions required for the shuttle 570 to travel between stops 578, 579, and the gear ratios provided by gears 590, 592, 594, 581, 588, 587, 588, 582 583, are related to the relative width of the suction apertures 21 with respect to the pitch P.

In yet other embodiments, rotation power may be provided by non-liquid based power sources, for example an electric motor, and the rotational power used for providing reciprocating axial motion in a similar manner to that described above, mutatis mutandis.

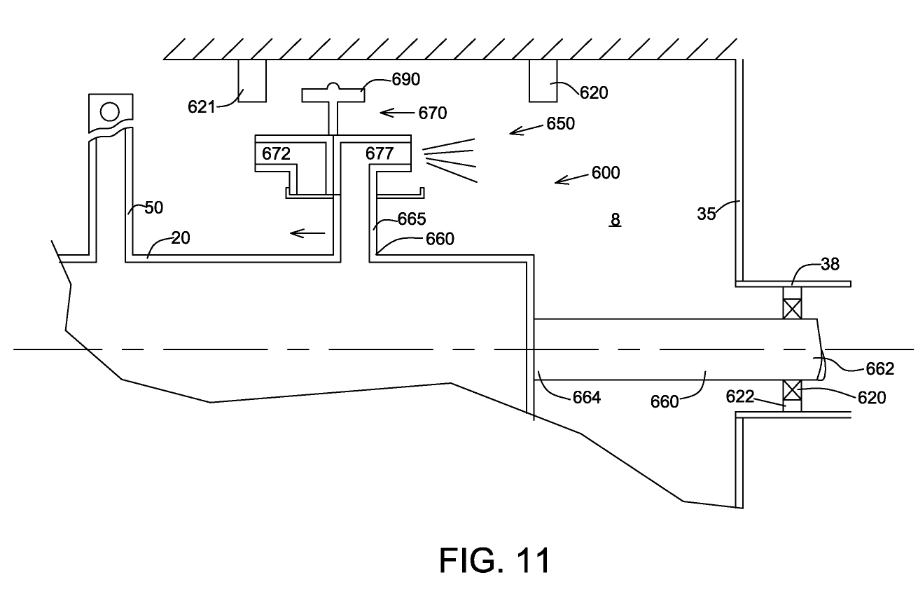

Referring to FIGS. 11 to 14, a sixth embodiment of the cleaning system of the present invention, generally designated with the numeral 600, comprises a manifold 20 including hydraulic motor 50 as described above, and a reciprocating mechanism 650.

In this embodiment, the reciprocating mechanism 650 may operate independently of the motor 50, and in fact the system may actually operate without the need for the rotational motor 50. In such a case, the arms 5 are connected at their radial ends to an annular collector (not shown) and the suction openings 21 may be in the form of a circumferential slit opposite to the inner cylindrical surface of the filter, or in the form of circumferentially-located closely-spaced discrete openings. In this case, it is only necessary to provide a reciprocal axial motion to the manifold 20 so that the full filter is scanned during the self-cleaning process, since the full inner circumferential periphery of the filter is covered by the annular collector at any axial position thereof. Accordingly, such an embodiment does not require the filter 4 to be cylindrical, and in fact the filter can have any cross-sectional shape, for example square, so long as the aforementioned “annular” collector comprises a complementary shape such that the suction openings, now in the form of a peripheral slit, are opposite to the inner surface of the filter.

Nevertheless, the reciprocating mechanism is advantageously coupled with the motor 50, and the combination is thus adapted for providing rotational motion and concurrent reciprocating linear motion along axis 30. Thus, the helical motion that may be provided to the suction apertures 21 and spray nozzles 11 are powered by the hydraulic motor 50 and reciprocating mechanism 650.

A cylindrical shaft 660 is axially and rigidly cantilevered at one end 664 thereof to end 32 of the conduit 16 of manifold 20 comprising the motor 50. The end 35 of the chamber 8 further comprises a tubular sleeve 38 adapted for reciprocably and rotatingly receiving the free end 662 of the shaft 660 by means of said sliding bearing arrangement 19. The sliding bearing arrangement 19 in this embodiment comprises a bearing 620, the inner rotating shell of which is mounted at the end 662, and the outer static shell being statically mounted to a sliding ring 622, which is adapted for sliding within said sleeve 38.

The reciprocation mechanism 650 comprises a linear dual-direction fluid motor 660, in the form of a plurality of arms 665 radially projecting from the end 32 of the conduit 16 of manifold 20. At the tip of each arm 660 a bi-directional nozzle 670 is provided, having two separate fluid passages 672, 677, each of which has an inlet, 673, 678, respectively, and an outlet, 674, 679, respectively. The inlets 673, 678 are coplanar, and each can be alternately aligned with the mouth 667 at the free end of the arm 665 by sliding the nozzle 670 axially along rail 680 in one direction or the other. The rail 680 comprises blanks 684, 685 for blocking the one or other of the inlets 673, 678, respectively, when the other inlet is aligned with the mouth 667. The outlets 674, 679 are aligned parallel to axis 30, but in axially opposed directions. The nozzle 670 further comprises a tab arrangement 690 that alternately cooperates with one or another of a pair of spaced annular stop rings 610, 620 in chamber 8 to axially displace the nozzle 670 to a position in which one or another of the inlets 673, 678 is aligned with mouth 667. The tab arrangement 690 preferably comprises a free rolling wheel 695 that is mounted to the radial end of nozzle 670, with the axis of rotation radially aligned with respect to axis 30. The wheel 695 comprises a tread surface 696 adapted for alternate contact with one or the other of said rings 610, 620.

Thus, as the manifold 20 is rotated about axis 30 under the action of the liquid motor 50, the end 32 rotates together with shaft 660, and the linear motor 660, together with the manifold 20, is constrained to follow a reciprocating path as follows. Starting at or near end plate 35, the tab wheel 695 is pressed against stop 620 such as to slide the nozzle 670 to the position illustrated in FIG. 11, where inlet 677 is aligned with mouth 667, and inlet 673 is blocked. As liquid is ejected from outlet 679 in an axial direction towards end 35, a reaction force propels the manifold 20 in an axial direction away from end 35, at the same time as the manifold is rotating by virtue of the action of motor 50. Accordingly, the mass flow of liquid must be sufficient to provide motive power to motor 50 and liner motor 660.

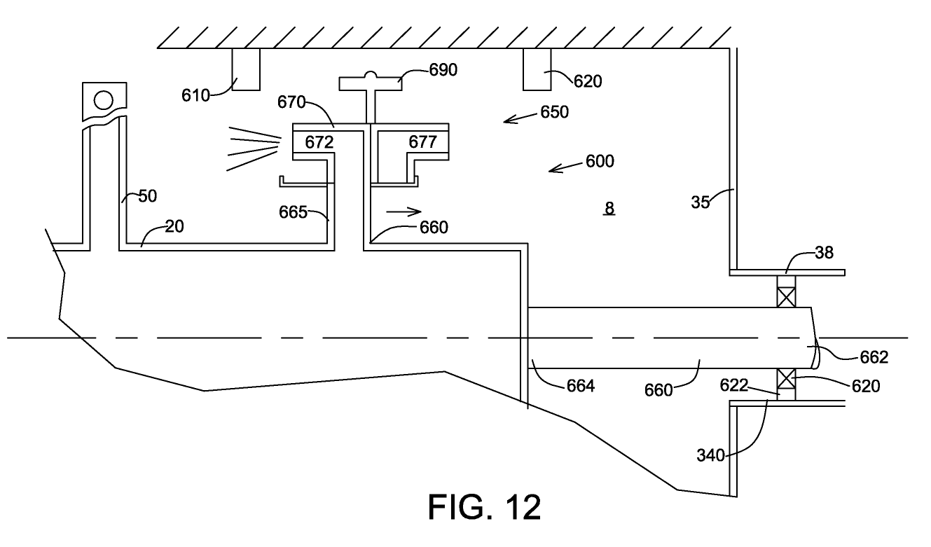

When the manifold 20 has nears its maximum displacement away from the end plate 35, wheel 695 presses against the stop 610, and the momentum of the manifold 20 may carry the same a little further, such as to slide the nozzle 670 to the position illustrated in FIG. 12. This operation is particularly facilitated by the rotation of wheel 695 along the annular ring 610 as the nozzle 670 is revolving about axis 30 under the action of motor 50. Now, inlet 673 is aligned with mouth 667, and inlet 677 is blocked. As liquid is ejected from outlet 674 in an axial direction away from end 35, a reaction force propels the manifold 20 in an axial direction towards end 35, at the same time as the manifold is rotating by virtue of the action of motor 50. When the manifold 20 has nears its minimum displacement with respect to the end plate 35, wheel 695 presses against the stop 620, and the momentum of the manifold 20 may carry the same a little further, such as to slide the nozzle 670 back to the position illustrated in FIG. 11.

So long as the linear motor 660 is operating, it will be translating the manifold 20 in one or the other axial directions. The full axial travel in either direction for the manifold 20, slightly more than the axial displacement between stops 610, 620, is typically correlated to the dimension of pitch P, and in some embodiments may be set similar to the dimension of P.

Optionally, the linear motor 660 may be adapted to operate such that the outlets 674, 679, or another part of the nozzle 670 alternately cooperates with the ring stops 610, 620, and in such a case the tab arrangement 690 is not required and may be dispensed with.

Clearly, if the motor 50 is disabled, for example by blocking apertures 25, it is still possible for the linear motor 660 to provide reciprocating movement to the manifold.

Alternatively, it is possible to slidingly mount the nozzles 670 to the arms 22 of the motor 50, by modifying the radial ends of the arms in a similar manner to that described for the radial ends of arms 665, mutatis mutandis. Such a modification to the sixth embodiment requires less parts overall, and shortens the axial dimension of the self-cleaning system. Optionally, the tangential nozzles 25 may be incorporated in the nozzle 670, and in fact each one of the said passages 672, 677 may comprise a said tangential nozzle 25 aligned in the same direction.

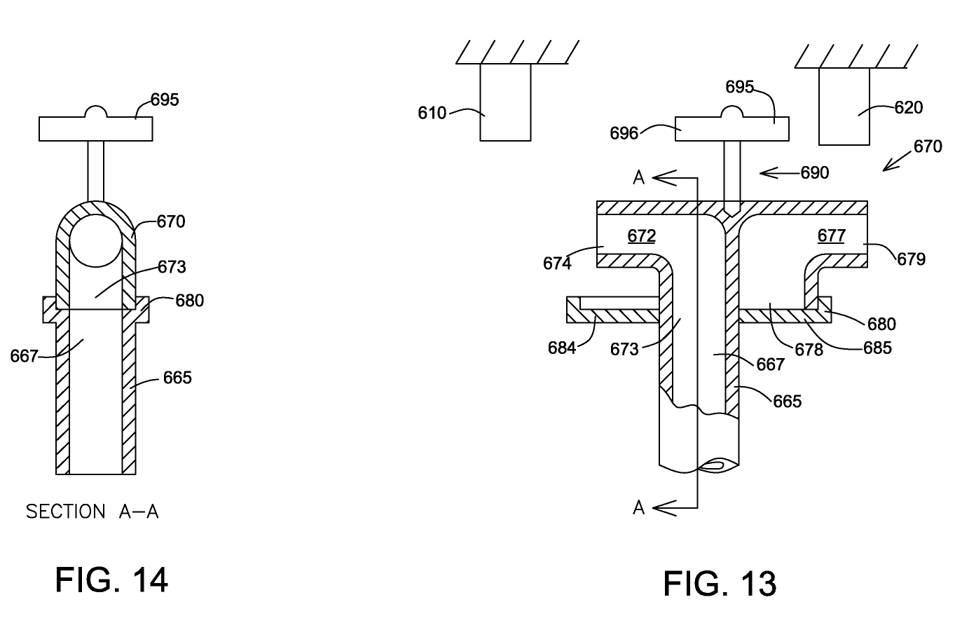

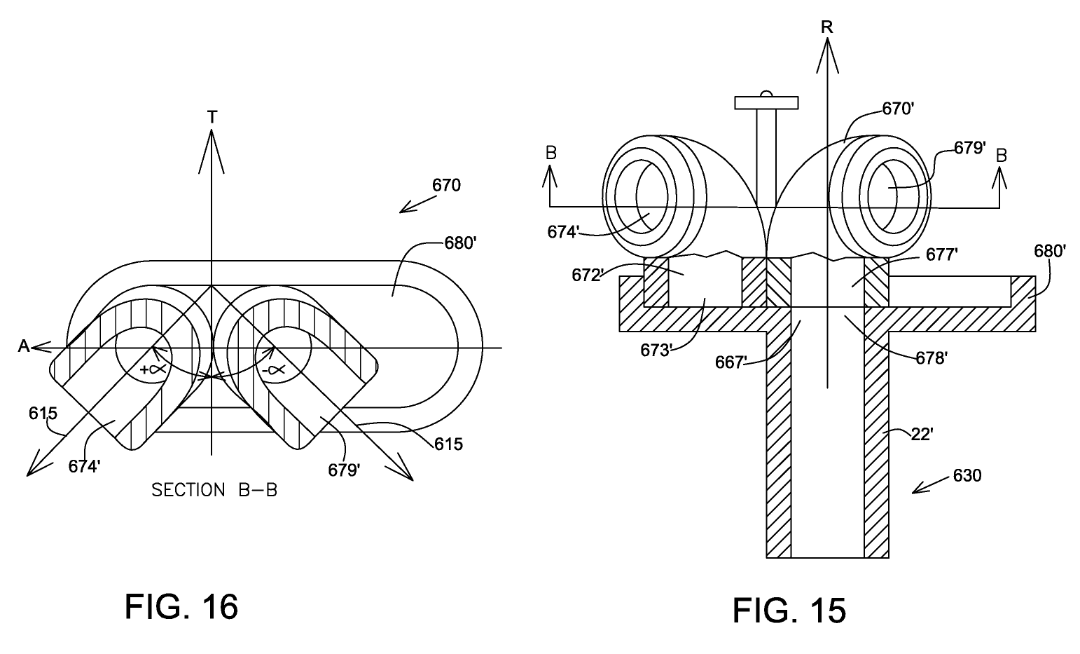

Alternatively, and referring to FIGS. 15 and 16, a seventh embodiment of the cleaning system of the present invention, generally designated with the numeral 700, is similar to the arrangement described above for the sixth embodiment, mutatis mutandis, with the following differences. In the seventh embodiment the rotational motor 50 and the linear motor 660 may be further combined such that arms 22′ of the combined motor 630 each comprise a vectored nozzle arrangement 670′ that provides a jet of liquid providing a reaction force component in the tangential direction T for providing rotation, and reaction force component in the axial direction A for providing axial displacement. Thus, the nozzle 670′ comprises two separate fluid passages 672′, 677′, each of which has an inlet, 673′, 678′, similar in construction and operation with respect to rail 680 as described with respect to the embodiment illustrated in FIGS. 13 and 14, mutatis mutandis. The respective outlets 674′, 679′, however, are aligned with their axes 615 at angles +α and −α to the tangential direction T, so that each nozzle may provide (in turn) a tangential reaction force component in the same tangential direction T, and an axial reaction force component parallel to axis 30, but in axially opposed directions. The nozzle 670′ further comprises a tab arrangement 690′ similar to that described in connection with tab 690 of the sixth embodiment, mutatis mutandis. Thus, in a similar manner to that described for the embodiment illustrated in FIGS. 11 to 14, mutatis mutandis, when the tab 690′ presses against ring stop 610, the nozzle 670′ is displaced so that inlet 677′ is blocked, and inlet 673′ is aligned with mouth 667′ of arm 22′. The action of the liquid exiting passage 672′ provides a reaction force that continues to turn the manifold 20 about axis 30, and that propels the same towards the end 35. When the tab 690′ eventually presses against the second stop ring 320, the nozzle 670′ slides with respect to rail 680′ to the position illustrated in FIGS. 15 and 16, so that inlet 673′ is blocked, and inlet 677′ is aligned with mouth 667′ of arm 22′. The action of the liquid exiting passage 672′ provides a reaction force that still continues to turn the manifold 20 about axis 30, but that now propels the same away from the end 35.

In other embodiments, rotational motion may be provided by a liquid turbine arrangement, for example, and the rotational power coupled to a reciprocating axial motion in a similar manner to that described above, mutatis mutandis.

It should be noted that the word “comprising” as used throughout the appended claims is to be interpreted to mean “including but not limited to”.

While there has been shown and disclosed exemplary embodiments in accordance with the invention, it will be appreciated that many changes may be made therein without departing from the spirit of the invention.

1. A self-cleaning system for use with a filter having a fluid inlet station, comprising:—
a manifold mountable at least for reciprocation along an axis with respect to said filter and comprising at least one suction opening adapted to be in proximity to said station and connectable to a suitable suction source for enabling foreign material to be removed from said filter when said system is installed and in operation with respect to said filter;
fluid powered motive means for propelling said manifold along said axis; and
a reciprocating mechanism for alternately changing the direction of motion of said manifold along said axis.

2. The system according to claim 1, wherein said manifold is also adapted for rotation about said axis, and said motive means comprises a rotational motor coupled to said reciprocating mechanism such as to provide a helical motion to said at least one suction opening.

3. The system according to claim 2, wherein said rotational motor comprises at least one arm radiating from said manifold and having a nozzle outlet in communication with said at least one suction opening, said nozzle outlet being tangentially disposed with a direction of rotation of said motor.

4. The system according to claim 2, wherein said rotational motor is coupled to said reciprocating mechanism to provide an endless helical motion to said at least one suction opening.

5. The system according to claim 4, wherein said system comprises a sliding bearing arrangement for mounting the system with respect to a housing comprising a said filter.

6. The system according to claim 2, wherein said rotational motor and said reciprocating mechanism comprise a follower coupled to a cylindrical cam arrangement, and wherein said cam comprises an endless track adapted for enabling the follower to reciprocate along said axis in response to a relative rotation between said cam and said follower about said axis.

7. The system according to claim 6, wherein said endless track comprises twin parallel helical tracks wound in opposite directions one with respect to another, and joined together at longitudinal ends via corner portions.

8. The system according to claim 6, wherein said cylindrical cam is fixedly mountable to a housing comprising said filter and said follower is mounted to said manifold for rotation therewith, when the system is installed with respect to said filter.

9. The system according to claim 5, wherein said follower is fixedly mountable to a housing comprising said filter and said cylindrical cam is mounted to said manifold for rotation therewith, when the system is installed with respect to said filter.

10. The system according to claim 2, wherein said rotational motor and said reciprocating mechanism comprise a follower coupled to an end cam arrangement, and wherein said end cam comprises an endless track adapted for enabling the follower to reciprocate along said axis in response to a relative rotation between said cam and said follower about said axis.

11. The system according to claim 10, wherein said endless track comprises an endless undulating contour comprising a plurality of peaks smoothly joined with a number of intercalated troughs, arranged in an annular manner.

12. The system according to claim 11, wherein said peaks and troughs merge into one another in a substantially sinusoidal manner in a circumferential direction.

13. The system according to claim 10, wherein said follower is mounted to a gear arrangement coupled to said rotational motor.

14. The system according to claim 13, wherein said gear arrangement comprises a planetary gear arrangement, wherein said rotational motor is mounted for rotation with a sun gear and said follower is mounted for rotation with an orbital gear of said planetary gear arrangement.

15. The system according to claim 10, wherein said end cam is fixedly mountable to a housing comprising said filter and said follower is mounted to said manifold for rotation therewith, when the system is installed with respect to said filter.

16. The system according to claim 10, wherein said follower is fixedly mountable to a housing comprising said filter and said end cam is mounted to said manifold for rotation therewith, when the system is installed with respect to said filter.

17. The system according to claim 2, wherein said rotational motor and said reciprocating mechanism comprise a shuttle arrangement mounted on an axial rail support for axial translation with respect thereto, said rail being fixedly mountable to a housing comprising said filter when the system is installed with respect to said filter, said shuttle being coupled to said rotational motor such that a rotation of said motor about said axis provides a translation of said shuttle along said rail.

18. The system according to claim 17, wherein said shuttle comprises:
a frame axially displaceable with respect to said rail and comprising a pivoting plate having two end pivot positions, said plate comprising a first gear means mounted for rotation at the pivot thereof and coupled to said rotational motor, said pivoting plate further comprising second and third gear means in mesh engagement with the other, wherein said second gear means is in mesh engagement with said first gear means via a fourth gear means carried on said pivoting plate;
first moving means coupled to a fifth gear means and second moving means coupled to a sixth gear means, each one of said second and third gear means being in alternate mesh engagement with one or the other of said fifth gear means and said sixth gear means in respective said end pivot positions of said plate; and
toggle means for pivoting said plate at each said end pivot position for reversing a direction of motion of said shuttle along said rail.

19. The system according to claim 18, wherein said second and third gear means comprise substantially the same pitch diameter.

20. The system according to claim 18, wherein said toggle means comprises an arm joined to said plate and extending radially from said plate, and adapted for interacting with one or another of fixed stops for pivoting said plate at each said end pivot position.

21. The system according to claim 18, further comprising a pin joined to said frame and extending through a slot in the plate.

22. The system according to claim 21, wherein said slot defines the end pivot positions of said plate.

23. System according to claim 18, wherein said first gear is coupled to said rotational motor via a worm gear arrangement.

24. The system according to claim 1, wherein said motive means comprises a fluid powered linear motor coupled to said reciprocating mechanism such as to provide at least axial reciprocating motion to said at least one suction opening.

25. The system according to claim 24, wherein said linear motor comprises at least one nozzle arrangement having a nozzle head comprising first and second fluid passages alternately in communication with a fluid source, said first and second fluid passages comprising fluid outlets at angles A and B, respectively to a tangential direction, said tangential direction being substantially parallel to said station when said system is installed and in operation with respect to said filter.

26. The system according to claim 25, wherein said nozzle head is slidingly mounted with respect to an arm between two end positions, said arm in communication with said fluid source, and comprising toggle means for sliding said nozzle head at each said end position for reversing a direction of motion of said at least one suction opening along said axis.

27. The system according to claim 26, wherein said toggle means comprises a tab joined to said nozzle head and extending away from a direction of said arm, and adapted for interacting with one or another of fixed stops for pivoting said plate at each said end pivot position.

28. The system according to claim 24, wherein angle A is about +90° and angle B is about −90°.

29. The system according to claim 28, wherein said manifold is also adapted for rotation about said axis.

30. The system according to claim 29, wherein said motive means further comprises a rotational motor coupled to said reciprocating mechanism such as to provide a helical motion to said at least one suction opening.

31. The system according to claim 30, wherein said system comprises a sliding bearing arrangement for mounting the system with respect to a housing comprising a said filter.

32. The system according to claim 24, wherein said manifold is also adapted for rotation about said axis, and wherein said motive means further rotational motion to said manifold, such as to provide a net helical motion to said at least one suction opening.

33. The system according to claim 32, wherein angle A is +α and angle B is −α, wherein the magnitude of α is substantially greater than 0° and less than about 90°.

34. The system according to claim 33, wherein the magnitude of α is about 45°.

35. The system according to claim 33, wherein said system comprises a sliding bearing arrangement for mounting the system with respect to a housing comprising a said filter.

36. The system according to claim 1, wherein said manifold comprises a plurality of arms radiating from a conduit coaxial with said axis, and comprising a said suction outlet at the extremity of each said arm.

37. The system according to claim 36, wherein said arms are located singly or in groups at axial locations uniformly distributed at a pitch P.

38. The system according to claim 37, wherein the axial travel of said system in one or another direction along said axis is correlated to said pitch P.

39. The system according to claim 38, wherein the number of revolutions of said manifold about said axis, the number of arms at each axial location, and the axial width of said suction openings are correlated to said pitch P.

40. The system according to claim 36, further comprising a spray nozzle at each said arm adapted for spraying a fluid towards said station when the system is installed in a housing comprising said filter.

41. The system according to claim 1, further comprising
a housing comprising a filter accommodated therein, said filter having a fluid inlet station, said housing having at least one fluid inlet in communication with fluid inlet station, and at least one fluid outlet in communication with a fluid outlet station of said filter;

42. A method for cleaning a filter having a fluid inlet station, comprising:—
reciprocating a manifold along an axis with respect to said filter, said manifold comprising at least one suction opening adapted to be in proximity to said station and connectable to a suitable suction source for enabling foreign material to be removed from said filter when said system is installed and in operation with respect to said filter, wherein a fluid powered motive means propels said manifold along said axis, and a reciprocating mechanism for alternately changing the direction of motion of said manifold along said axis.
